(19) United States
(12) Patent Application Publication
(10) Pub. No.: US 2016/0229501 A1
(43) Pub. Date: Aug. 11, 2016

(54) LIFESAVING BAG

(71) Applicants: CHENG-RUNG TSAI, New Taipei City (TW); YI-TING ZENG, Nantou City (TW)

(72) Inventors: CHENG-RUNG TSAI, New Taipei City (TW); YI-TING ZENG, Nantou City (TW)

(21) Appl. No.: 14/816,667

(22) Filed: Aug. 3, 2015

(30) Foreign Application Priority Data
Feb. 10, 2015 (TW) 104202166

(51) Int. Cl. B63C 9/26; A45C 7/00; A62B 35/00; A45C 9/00

(52) U.S. Cl. CPC B63C 9/26; A45C 9/00; A45C 7/0059; A62B 35/0043; A45C 2007/0009; A45C 2007/0013

(57) ABSTRACT

A lifesaving bag includes: a band, including a first side, a second side, a head end engaging section and a rear end engaging section; a zipper group, including a first zipper portion disposed at the first side, a second zipper portion disposed at the second side, and a zipper head adapted for engaging and disengaging the first zipper portion and the second zipper portion; a bottom portion, fixed with the rear end engaging section; a head portion, fixed with the head end engaging portion. When the first zipper portion and the second zipper portion are engaged, the band forms a hollow body, and the head portion and the bottom portion enclose upper and lower ends of the hollow body to form a bag. When the first zipper portion and the second zipper portion are disengaged, the band becomes a long strip-like rescue rope.

### FIELD OF THE INVENTION

The present invention relates to a lifesaving appliance, and particularly to an object that serves the purpose of a bag when assembled and as a rescue rope when deployed.

### BACKGROUND OF THE INVENTION

Unexpected potential hazards are inevitable when travelling for pleasure, particularly in more dangerous areas such as ponds, creeks and beaches. When an accompanying family member or friend accidentally falls into the water, or in the event of a drowning person nearby, how can one promptly offer help? Without knowing local waters in that territory, directly jumping into the water to rescue is an extremely dangerous act. The safest measure is to stay onshore, and to perform rescue according to the fundamental concept of “stretching” and “throwing”. As such, the safety of the rescuer can also be ensured. However, at the instant of learning a drowning person, how to immediately find a lifesaving appliance remains an issue to be solved by the present invention.

### SUMMARY OF THE INVENTION

In view of the above, in order to immediately find a lifesaving appliance for rescue at the instant of learning a drowning person, the present invention provides a lifesaving bag. The lifesaving bag of the present invention serves as a portable bag that readily carries objects one needs when one goes out, and may also be disassembled and deployed to become a rescue rope that provides immediate rescue.

The lifesaving bag of the present invention includes: a band, being long strip-shaped, including a first side, a second side, a head end engaging section and a rear end engaging section; a zipper group, including a first zipper portion, a second zipper portion and a zipper head, the first zipper portion disposed at the first side of the band, the second zipper portion disposed at the second side of the band, and the zipper head crossing and disposed between the first zipper portion and the second zipper portion and adapted for engaging and disengaging the first zipper portion and the second zipper portion; a bottom portion, joined and fixed with the rear end engaging section of the band along an edge of the bottom portion; and an head portion, joined and fixed with the head end engaging section of the band along an edge of the head portion. The first zipper portion and the second zipper portion may be engaged, such that the band becomes a hollow body, and the head portion and the bottom portion enclose upper and lower ends of the hollow body to form a bag. The first zipper portion and the second zipper portion may be disengaged, such that the band becomes a long strip-shaped rescue rope.

In one embodiment, the bottom portion includes a bottom sidewall that extends upward along a periphery of the bottom portion. An end of the bottom sidewall forms an open mouth. The rear end engaging section is fixed at the bottom sidewall, and has a slope relative to the bottom sidewall.

In one embodiment, a cover for sealing the open mouth is provided at the open mouth of the bottom sidewall, such that an accommodating chamber is formed among the bottom portion, the bottom sidewall and the cover. A float is disposed in the accommodating chamber.

In one embodiment, a zipper is provided between the bottom sidewall and the cover. The zipper allows the cover to open or close the open mouth.

In one embodiment, the float is made of an EVA foaming material.

In one embodiment, the head portion includes a head sidewall that extends downward along a periphery of the head portion. An end of the head sidewall forms an open mouth. The head end engaging section of the band is fixed at the head sidewall, and has a slope relative to the head sidewall.

In one embodiment, a strap is provided between the bottom portion and the head portion.

In one embodiment, the lifesaving bag further includes an inner bag. The inner bag may be placed in the hollow body formed by the band.

With the above technical solution, it is known that, compared to the prior art, the present invention substantially achieves following effects. First of all, the lifesaving bag of the present invention is formed by winding the band having the zipper. More specifically, the bag is enclosed and formed by the head portion on the top and the bottom portion at the bottom. The bag may hold objects and is easily portable for normal use. In the event of an emergency or a drowning person, the bag can be entirely pulled open to become an extremely long rope, which is then used or tossed to the drowning person for rescue. Secondly, the end that is tossed is the bottom portion of the bag and includes the float made of a high-density EVA foaming material that stays afloat and can be held onto by the drowning person. Further, the high-density foaming material has a weight for easy tossing. Thirdly, the float at the bottom portion of the bag provides the bag with buoyancy, and is thus capable of protecting a user carrying the bag from sinking when the users falls into the water.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an appearance according to an embodiment of the present invention.

FIG. 2 is a schematic diagram of FIG. 1 is a deployed state.

FIG. 3 is a schematic diagram of operations of the present invention.

FIG. 4 is a partial enlarged view of FIG. 3.

FIG. 5 is a first schematic diagram when the present invention is tossed to rescue a drowning person.

FIG. 6 is a second schematic diagram when the present invention is tossed to rescue a drowning person.

FIG. 7 is a perspective view of an appearance according to another embodiment of the present invention.

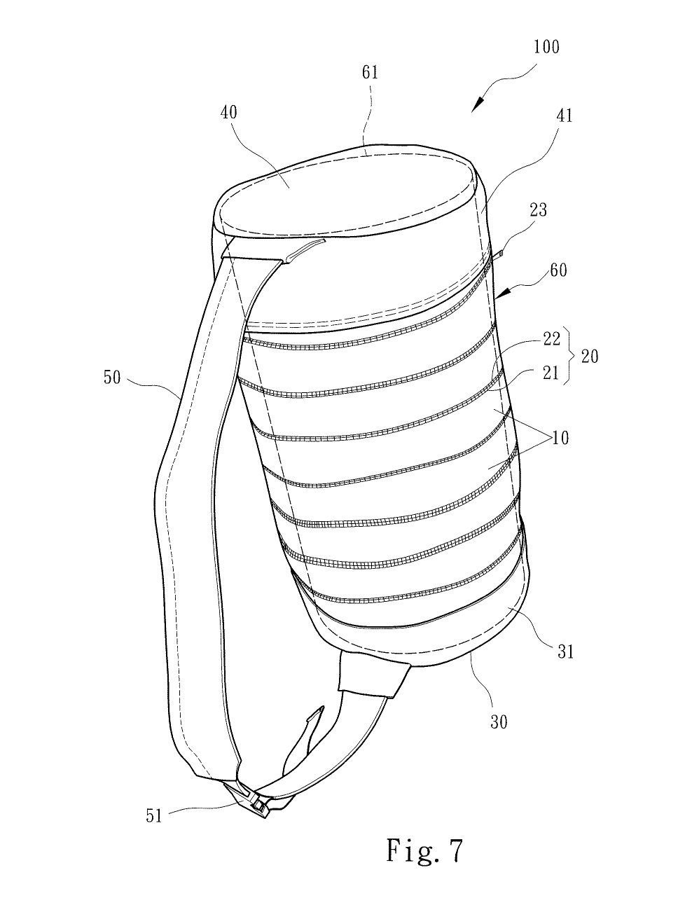

FIG. 8 is a schematic diagram of operations according to another embodiment of the present invention.

### DETAILED DESCRIPTION OF THE PREFERRED EMBODIMENTS

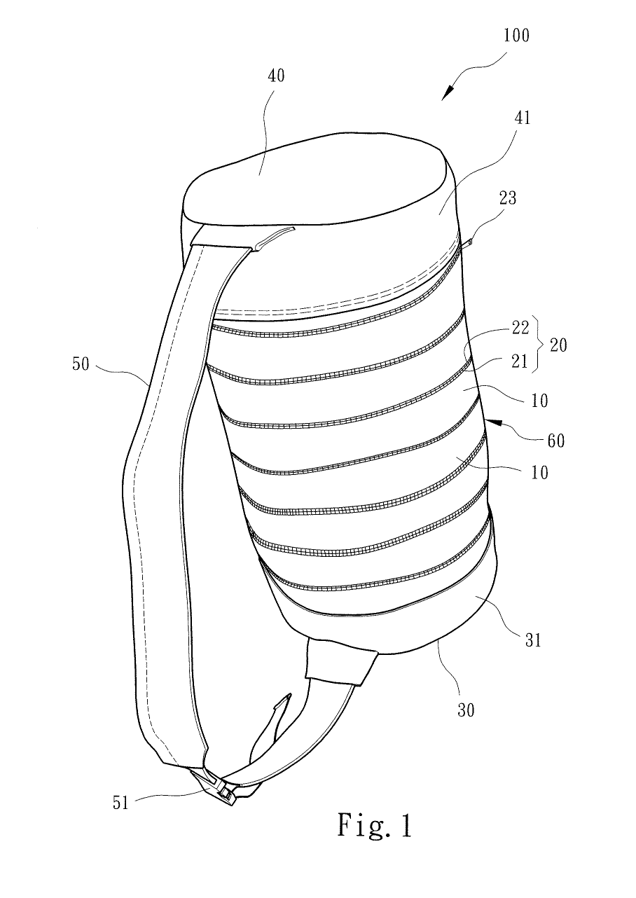

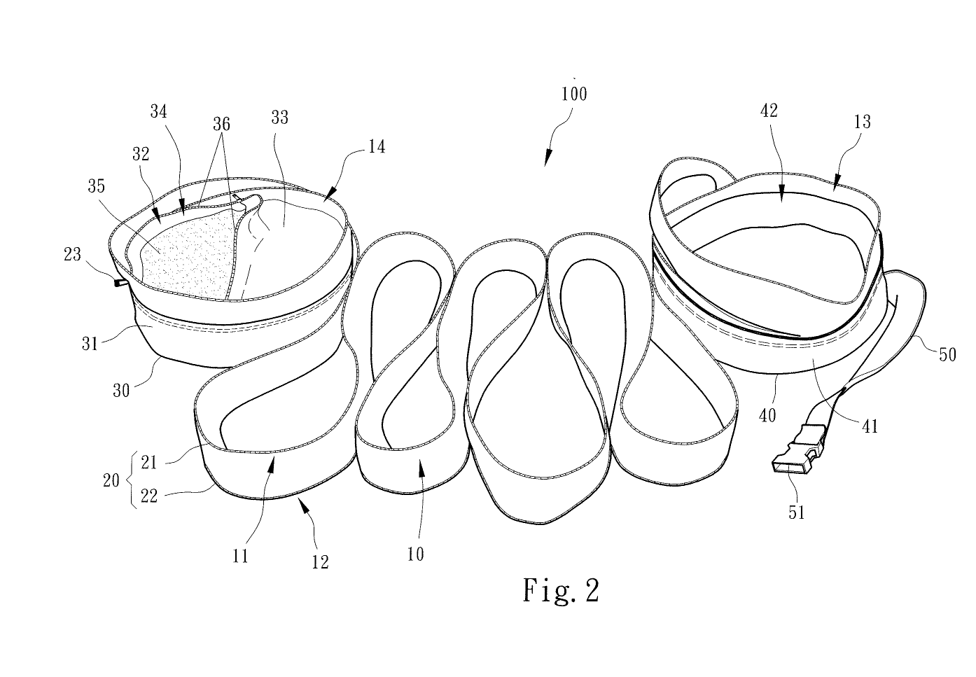

FIG. 1 shows a perspective view of an appearance of a lifesaving bag 100 according to an embodiment of the present invention. FIG. 2 shows a perspective view when the lifesaving bag 100 in FIG. 1 is deployed. In the embodiment, the lifesaving bag 100 includes a band 10, a zipper group 20, a bottom portion 30 and a head portion 40.

In the embodiment, the band 10 is long strip-shaped, and is made of a flexible material. In the embodiment, the band 10 is selected from a plastic material, e.g., PVC, which features characteristics of being water resistant, light and tough. The band 10 includes a first side 11, a second side 12, a head end engaging section 13 and a rear end engaging section 14. The band 10 currently adopted for manufacturing the bag is more than 5 meter (m).

In the embodiment, the zipper group 20 includes a first zipper portion 21, a second zipper portion 22 and a zipper head 23. The first zipper portion 21 is disposed at the first side 11 of the band 10. The second zipper portion 22 is disposed at the second side 12 of the band 10. The zipper head 23 crosses and is disposed between first zipper portion 21 and the second zipper portion 22, and is adapted to engage or disengage the first zipper portion 21 and the second zipper portion 22. The first zipper portion 21, the second zipper portion 22 and the zipper head 23 may be implemented by common commercial products. Associated structures and features are prior art, and shall be omitted here for brevity. Further, the zipper group 20 may be implemented by a water resistant zipper.

In the embodiment, the bottom portion 30 includes a bottom sidewall 31 that extends upward along the periphery of the bottom portion 30. An end of the bottom sidewall 31 forms an open mouth 32. The rear end engaging section 14 of the band 10 is fixed at the bottom sidewall 31, and has a slope relative to the bottom sidewall 31. As such, the band 10 is provided with moderateness when the band 10 is winded upward along the bottom sidewall 31, and the two may be joined by sewing. Further, a cover 33 for sealing the open mouth 32 is provided at the open mouth 32 of the bottom sidewall 31, such that an accommodating chamber 34 for accommodating a floating object 35 is formed among the bottom portion 30, the bottom sidewall 31 and the cover 33. Further, a zipper 36 is provided between the bottom sidewall 31 and the cover 33 to allow the cover 33 to open or close the open mouth 32.

The bottom portion 30 and the bottom sidewall 31 may made of fabric (e.g., canvas) or a plastic material (e.g., PVC). The floating object 35 may be made of a high-density foaming material, e.g., an EVA foaming material, which has a high density and good buoyancy. Thus, without involving a very large volume, the floating object 35 provides a substantial weight, and can be easily tossed to a farther position of a drowning person. Further, the zipper 36 may also be implemented by a water resistant zipper. By implementing the water resistant zipper collaborating with a watertight plastic material, when the floating object 35 is taken out of the accommodating chamber 34, the cover 33 can be closed to restore the accommodating chamber 34. The volume of the air in the accommodating chamber 34 is then used to produce buoyancy, in a way that the accommodating chamber 34 can serve as a float.

In the embodiment, the head portion 40 includes a head sidewall 41 that extends downward from the head portion 40. An end of the head sidewall 41 forms an open mouth 32. The head end engaging section 13 of the band 10 is fixed at the head sidewall 41, and has a slope relative to the head sidewall 41. As such, the band 10 is provided with moderateness when the band 10 is winded, and the two may be joined by sewing.

The head portion 40 and the head sidewall 41 may made of fabric (e.g., canvas) or a plastic material (e.g., PVC).

Again referring to FIG. 1, in the embodiment, a strap 50 is disposed between the bottom portion 30 and the head portion 40. The strap 50 includes a fastening member 51. In the embodiment, the strap 50 is implemented by a cross-body strap. One person skilled in the art can understand that, the strap 50 may also be in other forms, or may be a carrying strap. Such variations are within the scope of the present invention.

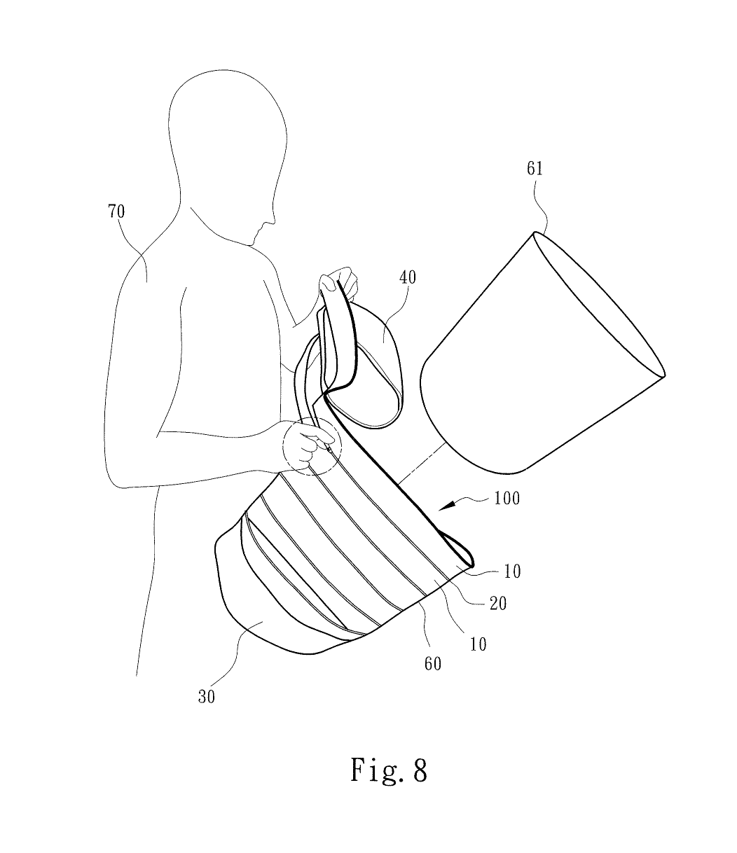

When the first zipper portion 21 and the second zipper portion 22 are engaged, the band 10 becomes a hollow body. The head portion 40 and the bottom portion 30 enclose the upper and lower ends of the hollow body to form a bag 60 (as shown in FIG. 1). When the first zipper portion 21 and the second zipper portion 22 are disengaged, the band 10 becomes a long strip-like rescue rope (as shown in FIG. 2). In one embodiment, the present invention further includes an inner bag 61 (as shown in FIG. 8). The inner bag 61 is disposed in the bag 60 formed by the head portion 40, the bottom portion 30 and the band 10. More specifically, the inner bag 61 is accommodated and however not fixed in the hollow body. Thus, when implemented under normal circumstances, the inner bag 61 may be used for storing objects. In an emergency rescue, a user may disengage the first zipper portion 21 and the second zipper portion 22 to cause the band 10 to become a long strip-like rescue rope for rescue purposes. As the inner bag 61 is not a part of the band 10, the inner bag 61 still maintains the function of storing objects. Further, the inner bag 61 may be provided with a drawstring or a structure for sealing, so as to prevent objects in the inner bag 61 from getting lost during the rescue process. Further, the inner bag 61 may also be provided with a carrying strap or a strap for a user to easily hand-carry or carry on the shoulders.

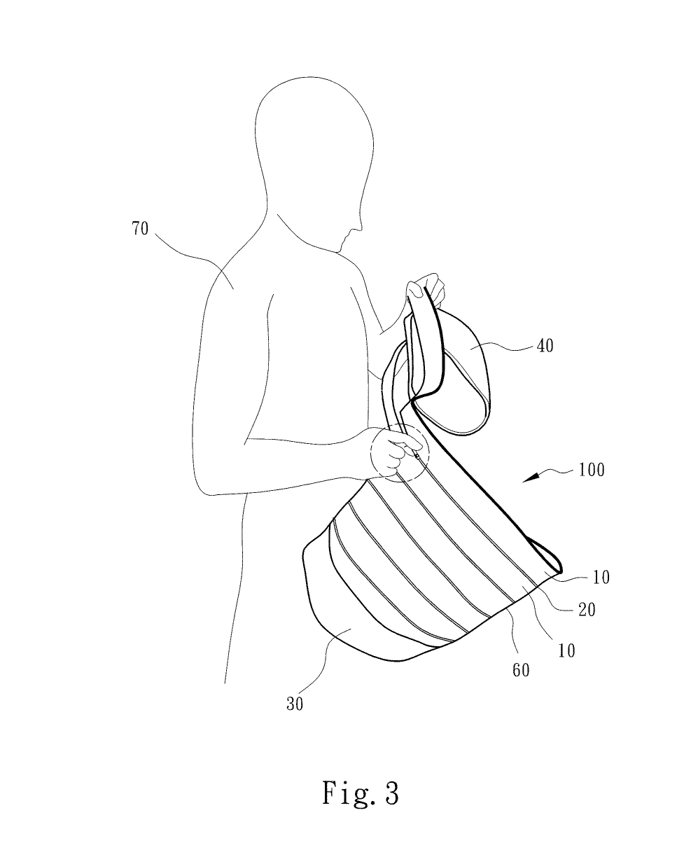

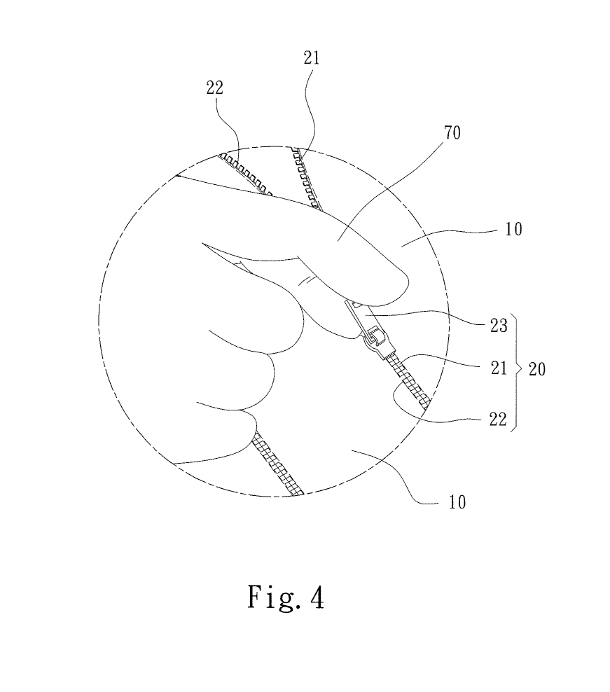

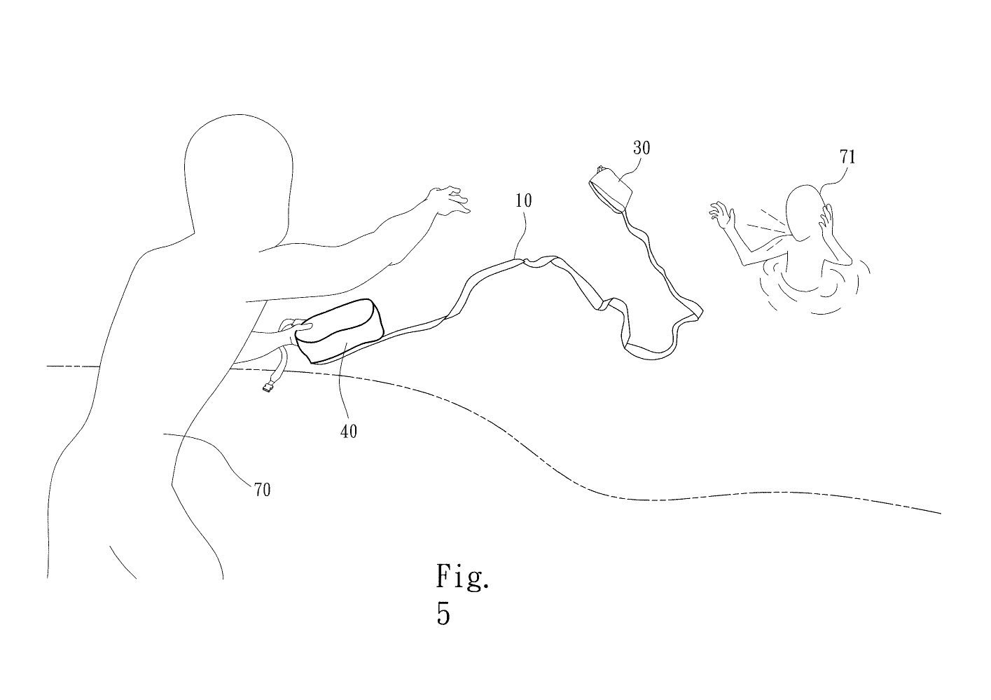

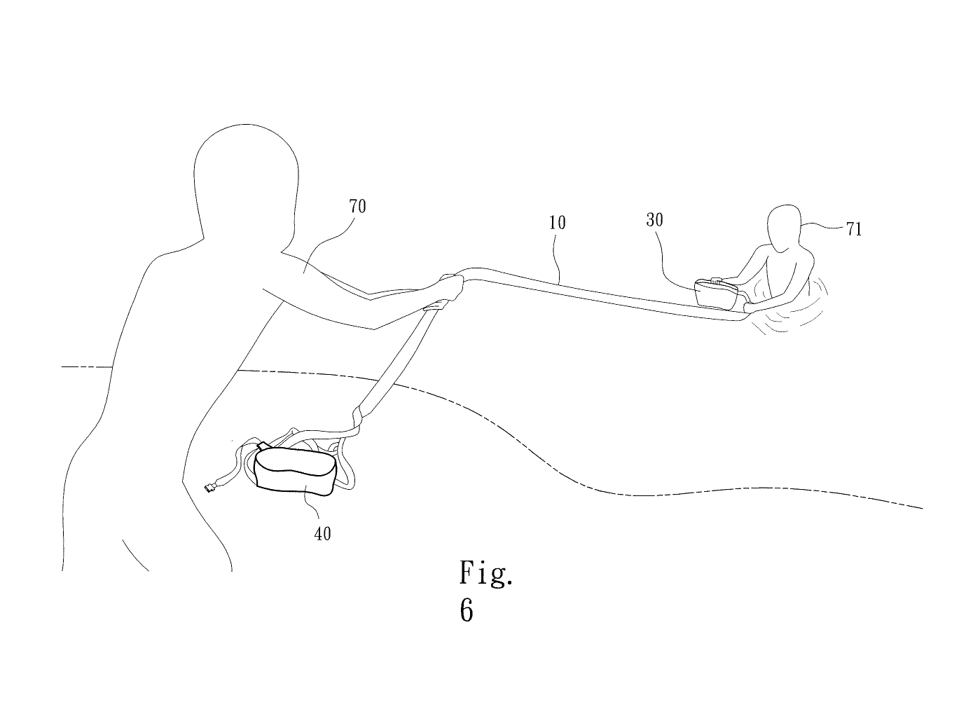

In the above description, details of components and the assembly method of the lifesaving bag 100 according to an embodiment are disclosed. Application characteristics of the lifesaving bag 100 are further given below. Referring to FIG. 3 and FIG. 4, in the application process of the present invention, a user 70 first takes out the inner bag 61, and disengages the first zipper portion 21 and the second zipper portion 22 using the zipper head 23 in FIG. 1. After being fully disengaged, the first zipper portion 21 and the second zipper portion 22 are in a state shown in FIG. 2. Fundamentally, the cover 33 seals the open mouth 32 of the bottom portion 30, such that the floating object 35 is secured and does not fall out. During the rescue for drowning, the head portion 40 or the band 10 near the head portion 40 is held by one hand, and the bottom portion 30 is held by the other hand and then tossed towards the direction of a drowning person 71 (referring to FIG. 5) or towards above the water current. Thus, the bottom portion 30 with the floating object 35 is allowed to flow along with the water current to the location of the drowning person 71. As the drowning person 71 catches and holds the bottom portion 30 or the band 10, the drowning person 71 can be pulled up (referring to FIG. 6). After the rescue, according to the foregoing method or steps, the zipper head 23 is pulled in a reverse direction to thoroughly engage the first zipper portion 21 and the second zipper portion 22, thereby completing the assembly of the bag 60 (as shown in FIG. 1). Because the bottom portion 30 and the head portion 40 of the band 10 are made of a floatable material, in addition to staying afloat when tossed into the water, the bottom portion 30 and the head portion 40 as well as the floating object 35 also provide the bag 60 with buoyancy to allow the drowning person 71 carrying the bag 60 to also become afloat. Moreover, in the implementation of the present invention, the cover 33 sealing the bottom portion 30 and the zipper 36 are made of a water resistant material. Therefore, when applying the present invention during a rescue process, water is prevented from seeping into the accommodating chamber 34 from the bottom portion 30. Further, with the cover 33 and the zipper 36 made of a water resistant material, when applying the present invention, the accommodating chamber 34 is allowed to stay enclosed and the air temporarily sealed in the accommodating chamber 34 thus produces buoyancy to reinforce the buoyancy of the bag 60.

What is claimed is:

1. A lifesaving bag, being characterized in comprising:
a band, being long strip-shaped, comprising a first side, a second side, a head end engaging section and a rear end engaging section;
a zipper group, comprising a first zipper portion, a second zipper portion and a zipper head, the first zipper portion disposed at the first side of the band, the second zipper portion disposed at the second side of the band, the zipper head crossing and disposed between the first zipper portion and the second zipper portion and adapted for engaging and disengaging the first zipper portion and the second zipper portion;
a bottom portion, fixed with the rear end engaging section of the band along an edge of the bottom portion;
a head portion, fixed the head end engaging section of the band along an edge of the head portion;
wherein, the first zipper portion and the second zipper portion are engaged, the band forms a hollow body, and the head portion and the bottom portion enclose upper and lower ends of the hollow body to form a bag; the first zipper portion and the second zipper portion are disengaged, and the band becomes a long strip-shaped rescue rope.

2. The lifesaving bag of claim 1, being characterized that, the bottom portion comprises a bottom sidewall that extends upward along a periphery of the bottom portion, an end of the bottom sidewall forms an open mouth, and the rear end engaging section of the band is fixed at the bottom sidewall and has a slope relative to the bottom sidewall.

3. The lifesaving bag of claim 2, being characterized that, a cover is provided at the open mouth of the bottom sidewall, such that an accommodating chamber is formed among the bottom portion, the bottom sidewall and the cover, and a float is placed in the accommodating chamber.

4. The lifesaving bag of claim 3, being characterized that, a zipper is provided between the bottom sidewall and the cover to allow the cover to open or close the open mouth.

5. The lifesaving bag of claim 3, being characterized that, the zipper group is implemented by a water resistant zipper.

6. The lifesaving bag of claim 3, being characterized that, the float is made of an EVA foaming material.

7. The lifesaving bag of claim 1, being characterized that, the head portion comprises a head sidewall that extends downward along a periphery of the head portion, an end of the head sidewall forms an open mouth, and the head end engaging section of the band is fixed at the head sidewall and has a slope relative to the head sidewall.

8. The lifesaving bag of claim 1, being characterized that, a strap is disposed between the bottom portion and the head portion.

9. The lifesaving bag of claim 1, being characterized in further comprising an inner bag that is placed in the hollow body formed by the bag.

10. The lifesaving bag of claim 1, being characterized that, the zipper group is implemented by a water resistant zipper.
